(19) United States
(12) Patent Application Publication
(10) Pub. No.: US 2005/0047414 A1
(43) Pub. Date: Mar. 3, 2005

(54) Communication control apparatus, communication system, and communication control method

(75) Inventors: Yoshiki Terashima, Kanagawa-ken (JP); Hiroyuki Aizu, Kanagawa-ken (JP); Keiichi Teramoto, Kanagawa-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, TOKYO (JP)

(21) Appl. No.: 10/923,014

(22) Filed: Aug. 23, 2004

(30) Foreign Application Priority Data
Aug. 28, 2003 (JP) 2003-304689

(51) Int. Cl. H04L 12/26

(52) U.S. Cl. 370/395.2; 370/252

(57) ABSTRACT

A communication control apparatus includes: an identification information sending unit configured to send communication identification information used by an outdoor communication control apparatus when the outdoor communication control apparatus accesses; and a connection determination unit configured to determine whether or not the outdoor communication control apparatus connects within a predetermined time after the communication identification information is sent, and to permit connection for the outdoor communication control apparatus when the outdoor communication control apparatus connects within the predetermined time.

### CROSS REFERENCE TO RELATED APPLICATIONS

This application claims benefit of priority under 35USC§119 to Japanese Patent Application No. 2003-304689, filed on Aug. 28, 2003, the entire contents of which are incorporated by reference herein.

### BACKGROUND OF THE INVENTION

Field of the Invention

The present invention relates to a communication control apparatus, a communication system, and a communication control method which are used for transmitting information with outdoor devices.

Related Background Art

When various household electrical appliances are connected to a network, it is possible, for example, to control a power supply of an air conditioner or the like via the network by a portable terminal from outdoors. This means to simplify implementation of service models for remote control of a wide variety of household electrical appliances, thereby realizing a system convenient and useful for users.

To achieve remote control, there have been proposed methods using various communication methods. Among others, a method of utilizing HTTP (HyperText Transfer Protocol) has come to particular attention in terms of general versatility, ease of packaging, and so forth (see Japanese Patent Application Laid-open Nos. 2000-059871 and 2001-331394).

As conventional methods of controlling from the outdoors, there have been known two types. The first type is a “direct access” method in which the web server is provided in the same indoor as that of an objective equipment to be controlled, and makes direct access to the Web server to issue a request to operate. The second method is a “polling”, one in which another Web server is placed on an external network and an indoor communication control apparatus periodically checks if it has received operational request.

These conventional methods have advantages and disadvantages, respectively. The first method can immediately notify of the operational request. That is, the first method excels in response. According to this method, however, an access point with an address directly accessible from the outdoors is necessary indoors. Because of this, it is unavailable for users who cannot prepare such a network environment.

The second method makes an access from the indoors to the outdoors. Because of this, it is available for all users in network environments where ordinary access to the Web server is possible. However, if the instructions for the outdoor web server are frequently checked at short period to process the given request with good response, communication cost required for the check becomes huge. Almost all systems of this kind lengthen the access interval. Because of this, almost all the systems adopt implementations that enlarge intervals of the check. In this case, since the operational request is transmitted with the interval of the check, the response of the operation deteriorates.

With these two methods, system configurations for offering services are also different from each other. Because of this, the conventional system for performing remote control emphasizes real-time performance, and offers services using the first method which makes direct access for only the users having environment capable of accessing from outside. Or the conventional system emphasizes to be applicable in environment of all the users, and offers the services using the second method which performs polling by providing a server for preserving the operational request to outdoor. That is, the conventional system has constructed either one of these two systems depending on the kind of the services.

In the case of using either one of the first and the second methods, it is impossible to receive any service in the environment where access from the outdoors is impossible, and even if there is an environment in which access from the outdoors is possible, the real time processing facility is limited since services are offered using the “polling” method.

To offer services satisfying many users, it is necessary to make direct access from an outdoor device and offer services by polling, but this requires implementations of two access methods, and it requires further cost.

### BRIEF SUMMARY OF THE INVENTION

It is therefore an object of the present invention to provide a communication control apparatus, a communication system, and a communication control method that permit easy and rapid access from outdoor to indoor equipment while maintaining stability of communication and security protection.

A communication control apparatus according to one embodiment of the present invention,
an identification information sending unit configured to send communication identification information used by an outdoor communication control apparatus when said outdoor communication control apparatus accesses; and
a connection determination unit configured to determine whether or not said outdoor communication control apparatus connects within a predetermined time after the communication identification information is sent, and to permit connection for said outdoor communication control apparatus when said outdoor communication control apparatus connects within the predetermined time.

A communication control apparatus according to one embodiment of the present invention, comprising:
an instruction acquisition request unit configured to send acquisition request of a remote control instruction for an outdoor communication control apparatus capable of storing the remote control instruction sent from a portable terminal; and
an instruction acquisition execution unit configured to acquire and execute the remote control instruction which is transmitted from said portable terminal and held by said outdoor communication control apparatus which has conducted instruction executing request, when the instruction executing request sent from said outdoor communication control apparatus is received.

A communication system according to one embodiment of the present invention, comprising:
an indoor communication control apparatus which is connected to a network and provided indoors;
an outdoor communication control apparatus which is connected to said network and provided outdoors; and
a portable terminal which performs wireless communication for said outdoor communication control apparatus,
wherein said outdoor communication control apparatus includes:
an instruction holding unit configured to hold a remote control instruction to be executed by said indoor communication control apparatus; and
an instruction acquisition request sending unit configured to send acquisition request of the remote control instruction sent from said portable terminal to said indoor communication control apparatus, when access to said indoor communication control apparatus is possible,
said indoor communication control apparatus includes:
a first instruction acquisition execution unit configured to periodically access said outdoor communication control apparatus in order to acquire and execute the remote control instruction held by said instruction holding unit, when access from said outdoor communication control apparatus is impossible;
an instruction execution request receiving unit configured to receive acquisition request of the remote control instruction sent from said outdoor communication control apparatus when access from said outdoor communication control apparatus is possible; and
a second instruction acquisition execution unit configured to acquire and execute the remote control instruction sent from said outdoor communication control apparatus which has conducted the acquisition request.

A communication control method according to one embodiment of the present invention, comprising:
sending communication identification information used by an outdoor communication control apparatus when said outdoor communication control apparatus accesses; and
determining whether or not said outdoor communication control apparatus connects within a predetermined time after sending the communication identification information, and permitting connection for said outdoor communication control apparatus when said outdoor communication control apparatus has connected within the predetermined time.

A communication control method according to one embodiment of the present invention, comprising:
sending acquisition request of a remote control instruction to an outdoor communication control apparatus capable of storing the remote control instruction sent from a portable terminal; and
acquiring and executing the remote control instruction which has been sent from said portable terminal and held by said outdoor communication control apparatus which has conducted an instruction execution request when the instruction execution request sent from said outdoor communication control apparatus is received.

A communication control method according to one embodiment of the present invention which communicates between an indoor communication control apparatus which is provided indoors and connected to a network, an outdoor communication control apparatus which is provided outdoors and connected to said network, and a portable terminal which performs wireless communication for said outdoor communication control apparatus,
wherein said outdoor communication control apparatus holds a remote control instruction which is to be executed by said indoor communication control apparatus and sent from said portable terminal, and sends acquisition request of the remote control instruction sent from said portable terminal to said indoor communication control apparatus when access to said indoor communication control apparatus is possible; and
wherein said indoor communication control apparatus periodically accesses said outdoor communication control apparatus, in order to acquire and execute the remote control instruction held by said instruction holding unit when access from said outdoor communication control apparatus is impossible; receives acquisition request of the remote control instruction sent from said outdoor communication control apparatus when access from said outdoor communication control apparatus is possible; and acquires and executes the remote control instruction from said outdoor communication control apparatus when acquisition request of the remote control instruction is received.

### BRIEF DESCRIPTION OF THE DRAWINGS

FIG. 1 is a block diagram showing an example of an entire configuration of a communication system according to one embodiment of the present invention.

FIG. 2 is a block diagram showing the internal configuration of each of the indoor and outdoor communication control apparatuses 2 and 3.

FIG. 3 is a block diagram showing the internal configurations of the network determination units 11 and 14 placed in the indoor and outdoor communication control apparatuses 2 and 3, respectively.

FIG. 4 is a sequence diagram showing the procedure by which a check is made to see if the outdoor-to-indoor connection is possible.

FIG. 5 is a block diagram showing the internal configuration of each of the indoor and outdoor remote control processing units 12 and 15.

FIG. 6 is a sequence diagram showing processing procedure by which the portable terminal 4 performs remote control, and shows the processing procedure in the case of not being able to access from the outdoors to the indoors.

FIG. 7 is a sequence diagram showing procedure of the remote control processing in the case of being able to access from the outdoor to the indoor.

### DETAILED DESCRIPTION OF THE INVENTION

An embodiment of the present invention will be described below with reference to the accompanying drawings.

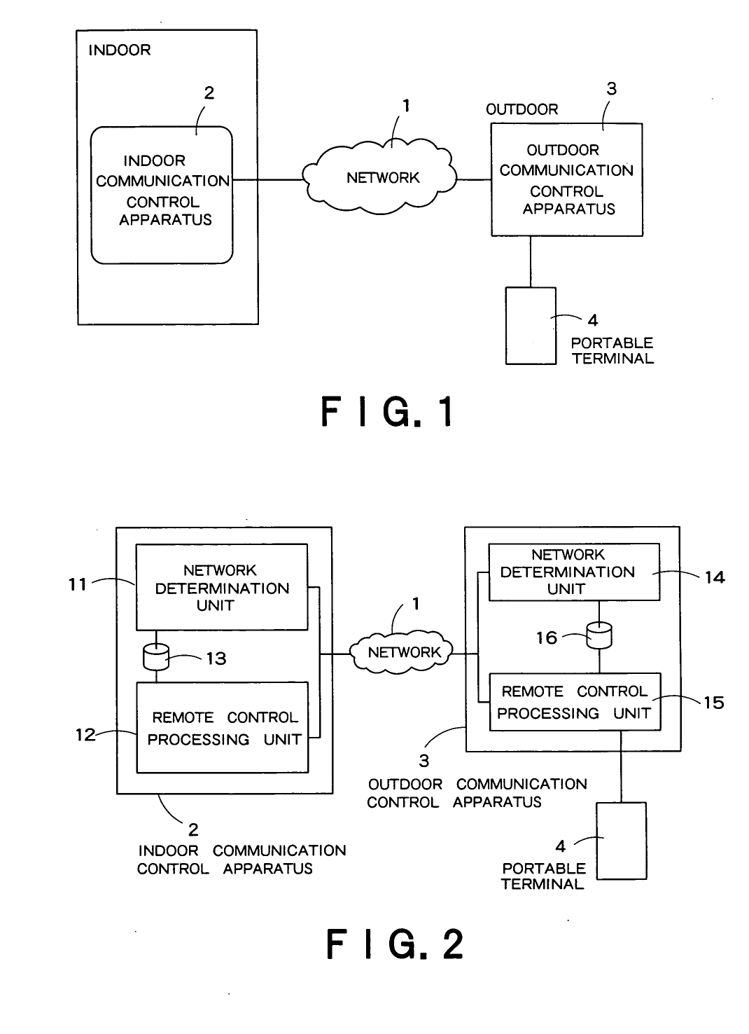

FIG. 1 is a block diagram showing an example of an entire configuration of a communication system according to the present invention. The illustrated communication system includes indoor and outdoor communication control apparatuses 2 and 3 both connected to a network 1 (for example, the Internet), and a portable terminal 4 which carries out radio communications with the outdoor communication control apparatus 3. The indoor communication control apparatus 2 shown in FIG. 1 is provided in a router, for instance.

Between the indoor communication control apparatus 2 and the network 1, a firewall may be provided to assure security. The indoor communication control apparatus 2 may communicate with indoor communication equipments via the indoor network.

The outdoor communication control apparatus 3 is accessible from the indoor communication control apparatus 2, but whether the control apparatus 2 is accessible from the control apparatus 3 depends on the user network environment.

The user uses the portable terminal 4 to remotely control the indoor communication control apparatus 2 (or indoor communication equipment connected to the indoor network via the indoor communication control apparatus 2) from the outdoors. At this time, the portable terminal 4 does not directly communicate with the indoor communication control apparatus 2 but instead communicates with the outdoor communication control apparatus 3 to remotely control the indoor communication control apparatus 2.

FIG. 2 is a block diagram showing the internal configuration of each of the indoor and outdoor communication control apparatuses 2 and 3. The indoor communication control apparatus 2 includes a network determination unit 11 for checking network environments, a remote control processing unit 12 for executing processing indicated by the portable terminal 4; and a storage unit 13 for storing work data or the like. The outdoor communication control apparatus 3 similarly includes a network determination unit 14 for checking network environments, a remote control processing unit 15 for sending contents of processing indicated by the portable terminal 4 to the indoor communication control apparatus 2 and a storage unit 16 for storing work data or the like.

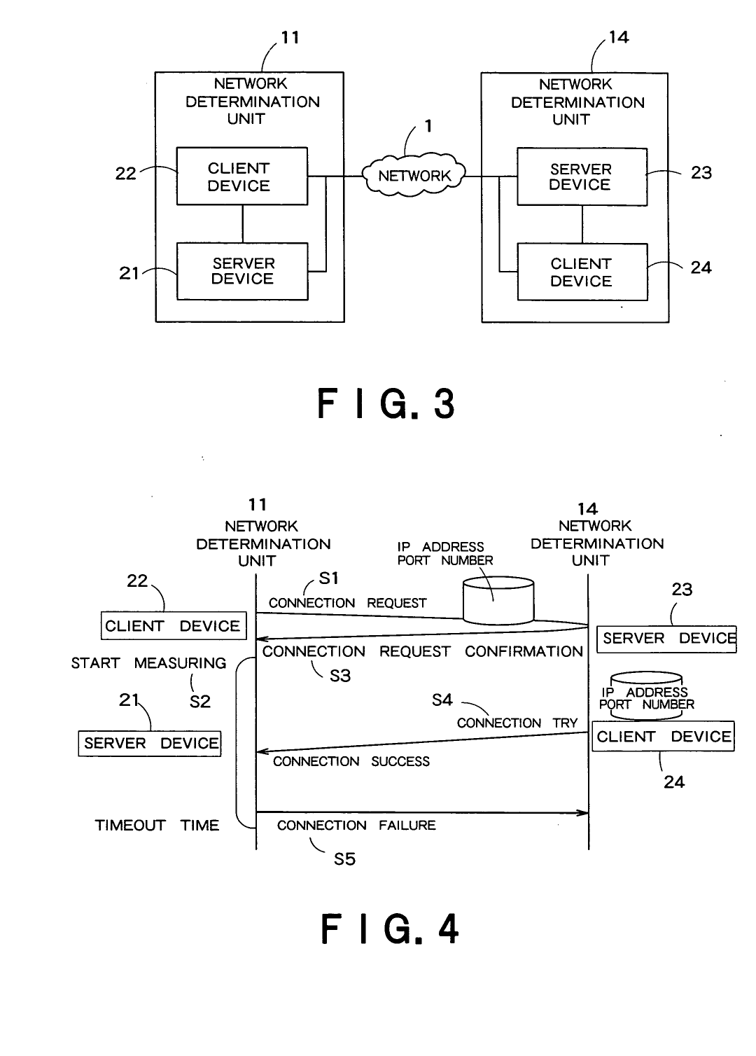

FIG. 3 is a block diagram showing the internal configurations of the network determination units 11 and 14 placed in the indoor and outdoor communication control apparatuses 2 and 3, respectively. The network determination unit 11 of the indoor communication control apparatus 2 has a server device 21 and a client device 22. Similarly, the network determination unit 12 of the outdoor communication control apparatus 3 also has a server device 23 and a client device 24.

The indoor client device 22 has functions of sending information about the indoor communication control apparatus 2, which is desired for external connection, such as its IP address and port number, via the network 1 to the outdoor server device 23 and waiting for an answer therefrom. The communication protocol for use in this case may be a unique one but may also be HTTP or HTTPS.

The indoor server device 21 normally stays out of operation but, for a certain period of time, it waits for an access from the outdoors so as to determine whether to permit or inhibit the access. This is done using the port number sent from the indoor client device 24 in advance. This port number may be such a fixed number as 80 of HTTP or 443 of HTTPS. Alternatively, it may be an arbitrary number randomly selected so that it does not collide with other programs running on the indoor communication control apparatus 2.

In order to improve security, the equipment that can be connected to the indoor communication control apparatus 2 may be limited only to (the IP address or domain name of) the outdoor communication control apparatus 3.

The outdoor server device 23 has the function of receiving information, such as the IP address and the port number for the indoor communication control apparatus 2, from the indoor client device 22 via the network 1 and delivering the information to the outdoor client device 24. It is also possible to check the IP address of the connection source instead of explicitly receiving the IP address from the client device 22.

The outdoor client device 24 has the function of attempting connection for the same IP address and port number.

FIG. 4 is a sequence diagram showing the procedure by which a check is made to see if the outdoor-to-indoor connection is possible. In the first place, the indoor client device 22 sends the IP address and port number of the indoor communication control apparatus 2 desired for external connection to the outdoor server device 23 to make a connection request (step S1). At the same time, the indoor server device 21 starts measuring the lapse of time after the connection request (step S2).

On receiving the connection request, the outdoor server device 23 sends an answer to the indoor client device 2 (step S3).

The outdoor server device 23 notifies the outdoor client device 24 of the received IP address and port number. The client device 24 specifies the IP address and port number, and makes several attempts at connection with the indoor server device 21 (step S4).

When the attempt at connection by the outdoor client 24 succeeds within a predetermined period of time after the start of measuring the elapse of time, the indoor server device 21 determines that the outdoor-to-indoor connection is possible. In the attempt at connection fails within the predetermined period of time, the indoor server device 21 determines that the connection is impossible. The indoor server device 21 sends the result of determination to the outdoor client 24 (step S5).

The indoor server device 21 verifies whether the outdoor client device 24 having succeeded in connection is genuine, through utilization of SSL (Secure Socket Layer) identification techniques, or by a method that the indoor client device 21 sends secret information to the outdoor server device 22, then receives the secret information sent back therefrom, and makes a check to determine if the two pieces of secret information match each other.

The above has described the procedure of determining whether the outdoor-to-indoor connection is possible. The determination procedure may be performed once prior to the execution of remote control by the portable terminal 4 described later on, or may be done periodically to monitor the connection environment at all times.

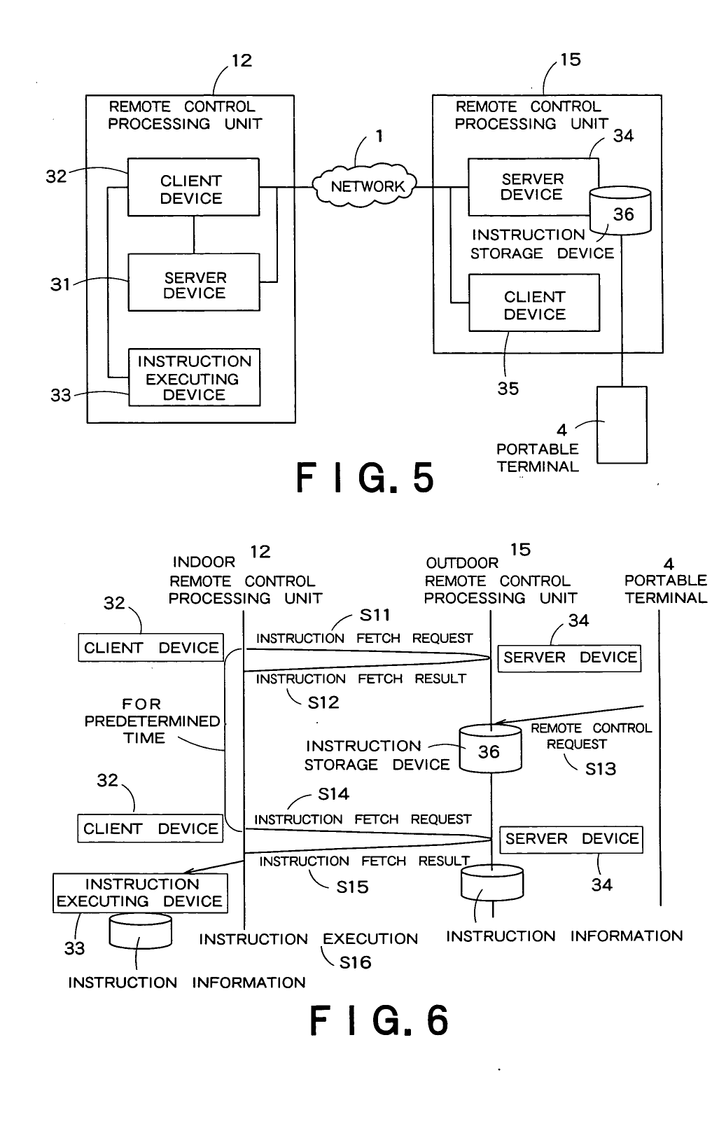

FIG. 5 is a block diagram showing the internal configuration of each of the indoor and outdoor remote control processing units 12 and 15. The indoor remote control processing unit 12 includes a server device 31, a client device 32, and an instruction executing device 33 that executes instructions designated by the portable terminal 4. The outdoor remote control processing unit 15 includes a server device 34, a client device 35, and an instruction storage device 36 that stores instructions designated by the portable terminal 4.

The indoor client device 32 accesses the outdoor server device 34 via the network 1, and acquires an instruction to be executed from the instruction storage device 36 connected to the server device 34. The thus acquired instruction is executed by the instruction executing device 33.

The instruction executing device 33 executes an instruction issued by the indoor communication control apparatus 2 and an instruction sent from the outdoor communication control apparatus 3.

The indoor server device 31 waits for communications from the outdoor client device 35, and upon receiving a request therefrom, informs it of the indoor client device 32 for acquisition of the instruction.

This embodiment can perform remote control by the portable terminal 4 in the same way as configurations of FIG. 1, irrespective of whether the indoors is directly accessible from the outdoors.

FIG. 6 is a sequence diagram showing processing procedure by which the portable terminal 4 performs remote control, and shows the processing procedure in the case of not being able to access from the outdoors to the indoors. In this instance, the client device 32 in the indoor remote control processing unit 12 operates at predetermined time intervals to request the server device 34 in the outdoor remote control unit 15 to acquire an instruction (step S11). The outdoor server device 34 checks whether an instruction for remote control is stored in the instruction storage device 36, and if not, then replies no storage (step S12). When there is no instruction to be executed, the indoor client device 32 does not perform any particular processing.

When the user uses the portable terminal 4 to access the outdoor communication control apparatus 3 and issues a request for remote control (step S13), a remote control instruction, which responds to a request, for example, “Turn ON Air Conditioner in Children's room”, is stored in the instruction storage device 36. At this time point, the instruction is merely stored and is not executed.

Thereafter, when the indoor client device 32, which operates at predetermined time intervals, resends the instruction acquisition request to the outdoor server device 34 (step S14). At this time point, the remote control instruction has been stored in the instruction storage device 36 (step S15). The client device 32 sends the instruction to the instruction executing device 33 to execute the instruction (step S16).

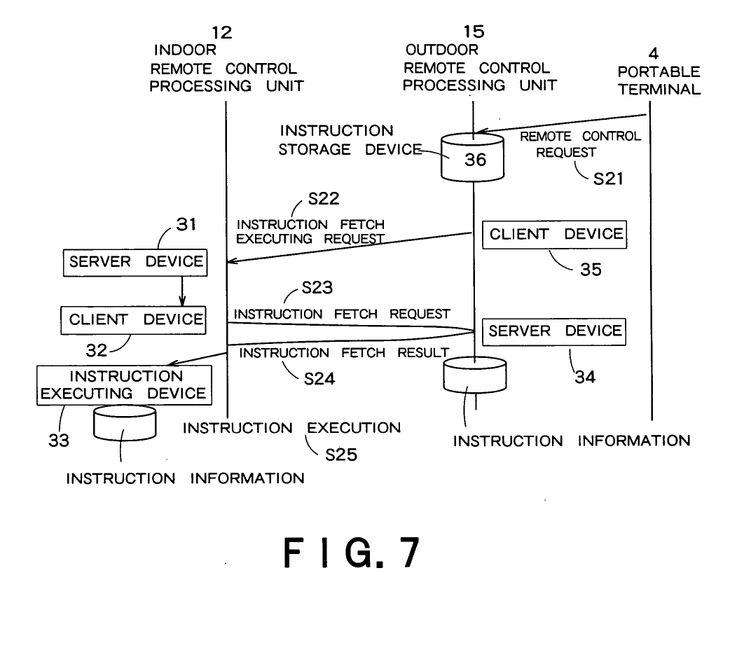

FIG. 7 is a sequence diagram showing procedure of the remote control processing in the case of being able to access from the outdoor to the indoor. In this instance, the server device 31 in the indoor remote control processing unit 12 continuously operates unlike in the case of FIG. 6.

When the user accesses the outdoor communication control apparatus 3, and requests the remote control by using the portable terminal 4 (step S21), a remote control instruction, which responds to a request, for instance, “Turn On Air Conditioner in Children's Room”, is stored in the instruction storage device 36.

At time point when the portable terminal 4 makes the request for remote control, the client device 35 starts to operate, and communicates with the indoor server device 31 to request fetch of instruction information (step S22). The server device 31 informs it of the indoor client device 32.

Thereafter, when the indoor client device 32 requests to the outdoor server device 34 to acquire an instruction (step S23), the server device 34 reads out the remote control instruction stored in the instruction storage device 36 (step S24), and sends the instruction to the indoor client device32. The client device 32 sends the instruction to the instruction execution device 33 for execution (step S25). As a result, the instruction designated by the user through the portable terminal 4 is executed by the indoor communication control apparatus 2.

The processing for storing an instruction in the instruction storage device 36 by accessing the outdoor communication control apparatus 3 from the portable terminal 4 and the processing for executing the instruction information acquired from the server device 34 in the outdoor remote control processing unit 15 by the client device 32 in the indoor remote control processing unit 3 are common to the configurations of FIGS. 6 and 7. Hence, substantially identical configuration can be used to perform the processing of FIGS. 6 and 7.

Since the indoor communication control apparatus 2 can be remotely controlled simply by accessing the outdoor communication control apparatus from the portable terminal 4, the user needs not to take into consideration the actual location of the indoor communication control apparatus 2.

As described above, only when the outdoor communication control apparatus 3 tries connection within a predetermined period of time after the indoor communication control apparatus 2 sends a connection request to the outdoor communication control apparatus 3, the connection from the outdoor communication control apparatus 3 is permitted. Accordingly, only the outdoor communication control apparatus 3 fit for communication is allowed to establish connection with the indoor communication control apparatus 2, and this stabilizes communication and provides increased security.

According to this embodiment, as shown in FIG. 6, in an environment where the outdoor-to-indoor access is impossible, the remote control instruction sent from the portable terminal 4 is stored in the outdoor communication control apparatus, and the indoor communication control apparatus 2 periodically accesses the outdoor communication control 3 to acquire the remote control instruction sent from the portable terminal 4 and execute the instruction. Even in the environment where the outdoor-to-indoor access is impossible, the indoor communication control apparatus 2 can be remotely controlled by the portable terminal 4.

Besides, according to this embodiment, as shown in FIG. 7, in the environment where the outdoor-to-indoor access is possible, upon receiving the remote control instruction from the portable terminal 4, the outdoor communication control apparatus 3 accesses the indoor communication control apparatus 2 and requests it to acquire the remote control information; hence, the remote control instruction from the portable terminal 4 can be quickly executed in the indoor communication control apparatus 3.

With the use of this embodiment, it is possible to control various digital household electrical appliances placed indoors from the portable terminal 4. More specifically, according to the present embodiment, control of the operation of an air conditioner or checking the numbers of contents kept in a refrigerator, for instance, can be done with ease.

At least portion of the communication system described in the above embodiment may be constituted as hardware or software. When the communication system are constituted as software, a program which realizes at least some functions of the communication system may be stored in a recording medium such as a floppy disk or a CD-ROM or the like, loaded on a computer, and then executed by the computer. The recording medium is not limited to a portable recording medium such as a magnetic disk or an optical disk. A fixed recording medium such as a hard disk drive or a memory may be used.

A program which realizes at least some functions of the communication system may be distributed through a communication network (including wireless communication) such as the Internet or the like. In addition, the program may be coded, modulated, or compressed and then distributed through a cable network or a wireless network such as the Internet. Alternatively, the program may be distributed being stored in a recording medium.

1. A communication control apparatus, comprising:
an identification information sending unit configured to send communication identification information used by an outdoor communication control apparatus when said outdoor communication control apparatus accesses; and
a connection determination unit configured to determine whether or not said outdoor communication control apparatus connects within a predetermined time after the communication identification information is sent, and to permit connection for said outdoor communication control apparatus when said outdoor communication control apparatus connects within the predetermined time.

2. The communication control apparatus according to claim 1, further comprising a determination result response unit configured to respond a result determined by said connection determination unit to said outdoor communication control apparatus.

3. The communication control apparatus according to claim 1, further comprising a confirmation signal receiving unit configured to receive a confirmation signal for the communication identification information sent to said outdoor communication control apparatus,
wherein said connection determination unit starts measurement of a time elapsed after the confirmation signal is received and the communication identification information is sent.

4. A communication control apparatus, comprising:
an instruction acquisition request unit configured to send acquisition request of a remote control instruction for an outdoor communication control apparatus capable of storing the remote control instruction sent from a portable terminal; and
an instruction acquisition execution unit configured to acquire and execute the remote control instruction which is transmitted from said portable terminal and held by said outdoor communication control apparatus which has conducted instruction executing request, when the instruction executing request sent from said outdoor communication control apparatus is received.

5. The communication control apparatus according to claim 4, wherein said instruction acquisition execution unit periodically accesses said outdoor communication control apparatus when access from said outdoor communication control apparatus is impossible, and acquires and executes the remote control instruction held by said outdoor communication control apparatus.

6. The communication control apparatus according to claim 4, further comprising an instruction executing request receiving unit configured to receive the instruction executing request from said outdoor communication control apparatus when access from said outdoor communication control apparatus is possible.

7. The communication control apparatus according to claim 4, wherein the instructions issued by said portable terminal are stored in an instruction holding unit in said outdoor control apparatus;
said instruction acquisition execution unit periodically acquires the instructions stored in said instruction holding unit upon accessing said outdoor communication control apparatus, and acquires the instructions stored in said instruction holding unit when said instruction executing request is received.

8. A communication system, comprising:
an indoor communication control apparatus which is connected to a network and provided indoors;
an outdoor communication control apparatus which is connected to said network and provided outdoors; and
a portable terminal which performs wireless communication for said outdoor communication control apparatus,
wherein said outdoor communication control apparatus includes:
an instruction holding unit configured to hold a remote control instruction to be executed by said indoor communication control apparatus; and
an instruction acquisition request sending unit configured to send acquisition request of the remote control instruction sent from said portable terminal to said indoor communication control apparatus, when access to said indoor communication control apparatus is possible,
said indoor communication control apparatus includes:
a first instruction acquisition execution unit configured to periodically access said outdoor communication control apparatus in order to acquire and execute the remote control instruction held by said instruction holding unit, when access from said outdoor communication control apparatus is impossible;
an instruction execution request receiving unit configured to receive acquisition request of the remote control instruction sent from said outdoor communication control apparatus when access from said outdoor communication control apparatus is possible; and
a second instruction acquisition execution unit configured to acquire and execute the remote control instruction sent from said outdoor communication control apparatus which has conducted the acquisition request.

9. The communication system according to claim 8, wherein said outdoor communication control apparatus holds the remote control instruction in said instruction holding unit when said outdoor communication control apparatus cannot access said indoor communication control apparatus, until the remote control instruction sent from said portable terminal is received, and then said indoor communication control apparatus accesses afterward.

10. The communication system according to claim 8, wherein said instruction acquisition request sending unit conducts the acquisition request of the remote control instruction for said indoor communication control apparatus when said outdoor communication control apparatus can access said indoor communication control apparatus, at time when the remote control instruction from said portable terminal is received.

11. A communication control method, comprising:
sending communication identification information used by an outdoor communication control apparatus when said outdoor communication control apparatus accesses; and
determining whether or not said outdoor communication control apparatus connects within a predetermined time after sending the communication identification information, and permitting connection for said outdoor communication control apparatus when said outdoor communication control apparatus has connected within the predetermined time.

12. The communication control method according to claim 11, wherein a result of the determination is sent back to said outdoor communication control apparatus.

13. The communication control apparatus according to claim 11, wherein a confirmation signal for communication identification information transmitted to said outdoor communication control apparatus are received; and
after the confirmation signal is received, a measurement of a time elapsed after the communication identification information is sent is started.

14. A communication control method, comprising:
sending acquisition request of a remote control instruction to an outdoor communication control apparatus capable of storing the remote control instruction sent from a portable terminal; and
acquiring and executing the remote control instruction which has been sent from said portable terminal and held by said outdoor communication control apparatus which has conducted an instruction execution request when the instruction execution request sent from said outdoor communication control apparatus is received.

15. The communication control method according to claim 14, wherein when access from said outdoor communication control apparatus is impossible, access to said outdoor communication control apparatus is periodically conducted, and the remote control instruction held by said outdoor communication apparatus is acquired and executed.

16. The communication control method according to claim 14, wherein when access from said outdoor communication control apparatus is possible, the instruction execution request from said outdoor communication control apparatus is received.

17. The communication control apparatus according to claim 14, wherein instructions issued by said portable terminal are stored in an instruction holding unit in said outdoor communication control apparatus; and
the instructions stored in said instruction holding unit are acquired when accesses to said outdoor communication control apparatus are periodically conducted, and the instructions stored in said instruction holding unit are acquired when the instruction execution request is received.

18. A communication control method which communicates between an indoor communication control apparatus which is provided indoors and connected to a network, an outdoor communication control apparatus which is provided outdoors and connected to said network, and a portable terminal which performs wireless communication for said outdoor communication control apparatus,
wherein said outdoor communication control apparatus holds a remote control instruction which is to be executed by said indoor communication control apparatus and sent from said portable terminal, and sends acquisition request of the remote control instruction sent from said portable terminal to said indoor communication control apparatus when access to said indoor communication control apparatus is possible; and
wherein said indoor communication control apparatus periodically accesses said outdoor communication control apparatus, in order to acquire and execute the remote control instruction held by said instruction holding unit when access from said outdoor communication control apparatus is impossible; receives acquisition request of the remote control instruction sent from said outdoor communication control apparatus when access from said outdoor communication control apparatus is possible; and acquires and executes the remote control instruction from said outdoor communication control apparatus when acquisition request of the remote control instruction is received.

19. The communication control method according to claim 18, wherein said outdoor communication control apparatus holds the remote control instruction in said instruction holding unit when said outdoor communication control apparatus cannot access said indoor communication control apparatus, after the remote control instruction from said portable terminal is received, until said indoor communication control apparatus accesses afterward.

20. The communication control method according to claim 18, wherein acquisition request of the remote control instruction is performed for said indoor communication control apparatus when said outdoor communication control apparatus can access said indoor communication control apparatus, at time when the remote control instruction from said portable terminal is received.
